(19) United States
(12) Patent Application Publication
(10) Pub. No.: US 2019/0056289 A1
(43) Pub. Date: Feb. 21, 2019

(54) SYSTEM AND METHOD FOR CALIBRATING A VIBRATION TRANSDUCER

(71) Applicant: PRUEFTECHNIK DIETER BUSCH AG, Ismaning (DE)

(72) Inventor: Heinrich LYSEN, Garching (DE)

(73) Assignee: PRUEFTECHNIK DIETER BUSCH AG, Ismaning (DE)

(21) Appl. No.: 16/102,208

(22) Filed: Aug. 13, 2018

(30) Foreign Application Priority Data
Aug. 17, 2017 (DE) 10 2017 118 765.0

(51) Int. Cl. G01M 7/02

(52) U.S. Cl. CPC G01M 7/025

(57) ABSTRACT

A system for calibrating a test vibration transducer having at least one vibration measurement channel, including a vibration generator, a reference vibration transducer, a fastening device for rigidly coupling the reference vibration transducer to the test vibration transducer, in order to set the reference vibration transducer and the test vibration transducer into vibrations jointly. The vibration generator, and an analysis unit, wherein the reference vibration transducer is designed to output a corresponding reference measurement channel for each vibration measurement channel of the test vibration transducer and also at least one additional reference measurement channel for an additional degree of freedom to the analysis unit. The analysis unit has an input for each vibration measurement channel of the test vibration transducer and is designed to offset the vibration measurement signals of the test vibration transducer with the reference signals.

### CROSS-REFERENCE TO RELATED APPLICATIONS

This application claims foreign priority benefits under 35 U.S.C. § 119(a)-(d) to DE 10 2017 118 765.0 Application Serial No. filed Aug. 17, 2017, the disclosure of which is hereby incorporated in its entirety by reference herein.

### TECHNICAL FIELD

The invention relates to a system and a method for calibrating a vibration transducer.

### BACKGROUND

A vibration generator having a reference vibration transducer, which generates a sinusoidal mechanical vibration signal having known amplitude and frequency, is typically used in the calibration of vibration transducers, wherein one frequently selected frequency is 149.2 Hz, because then equal numeric values result for the amplitudes of the three vibration variables vibration acceleration, vibration velocity, and vibration displacement (in SI units) (one such configuration is also referred to as a vibration calibrator or calibration table).

Instead of an integrated reference vibration transducer, the reference vibration transducer can also be connected, for example, in a “back-to-back” configuration to the test vibration transducer to be calibrated, wherein the two connected vibration transducers are then set into vibrations by a vibration generator (also referred to as a “shaker”). During the calibration of the test vibration transducer, the measurement signals of the test vibration transducer and the reference vibration transducer are then compared, in order to ascertain the sensitivity and relative phasing of the test vibration transducer. One example of such a configuration is shown in U.S. Pat. No. 8,577,641 B2.

### SUMMARY

An assembly for calibrating a six-axis vibration sensor, which comprises the movement of the vibration sensor along the three linear spatial axes and rotations of the vibration sensor about three axes of rotation, is shown in KR 1020130030156 A, wherein a vibration generator is used which can also set the vibration sensor into torsional vibrations.

An assembly for calibrating a vibration transducer is described in DE 34 17 826 A1, wherein the vibrations of the vibration transducer generated with the aid of a vibration generator are measured with the aid of a laser interferometer, in order to evaluate the measurement signal of the vibration transducer.

A system for calibrating vibration transducers is available from Brüel & Kjaer under the type designation 3629, wherein the vibration generator is designed for a broadband vibration excitation and firstly a reference transfer function or a reference spectrum of the vibration excitation is recorded by means of a reference vibration transducer and subsequently the reference vibration transducer is replaced by the test vibration transducer, in order to ascertain the corresponding transfer function of the test vibration transducer; in this case, the reference transfer function is used to calibrate the test vibration transducer.

It is the object of the present invention to provide a system and a method for calibrating a test vibration transducer, which enable accurate calibration in a simple manner.

This object is achieved according to the invention by a system according to Claim 1 and a method according to Claim 15.

In the solution according to the invention, the reference vibration transducer outputs a corresponding reference measurement channel for each vibration measurement channel of the test vibration transducer and also at least one additional reference measurement channel for an additional degree of freedom to the analysis unit, and therefore not only sensitivity and phase of the signals of the test vibration transducer, but rather also misorientations of the measurement axes of the test vibration transducer in relation to the measurement axes of the reference vibration transducer can be determined. Particularly accurate calibration is thus enabled. In particular, bending vibrations can thus also be recognized, which result from asymmetries in the measurement configuration (displacements of the mass centre of gravity, displacements and tilts of the axes of the vibration transducers) and can corrupt the measurement results. Relatively small transportable vibration generators can also be used by way of such an improved reference measurement.

The test vibration transducer preferably has three vibration measurement channels corresponding to the three spatial axes, wherein the reference vibration transducer outputs at least one reference measurement channel in each case for all six degrees of freedom.

Preferably, the vibration generator outputs a force signal for each spatial direction of the vibration excitation corresponding to the force applied for the vibration excitation in this spatial direction, from which the complex mechanical impedance of the overall system consisting of test vibration transducer, reference vibration transducer, and vibration generator can then be ascertained. In this manner, the accuracy of the calibration can be enhanced, since additional items of information about the overall system are available on the basis of the complex mechanical impedance and can be used in the analysis.

Further preferred embodiments of the invention result from the dependent claims.

### BRIEF DESCRIPTION OF THE DRAWINGS

The invention will be explained in greater detail hereafter by way of example on the basis of the appended drawings. In the figures:

FIG. 1 shows a schematic illustration of a system according to the invention for calibrating vibration transducers;

FIG. 2 shows a schematic example of an ideal assembly for calibrating a vibration transducer in one spatial direction; and

FIG. 3 shows an illustration corresponding to FIG. 2, wherein a real configuration is illustrated, however.

### DETAILED DESCRIPTION

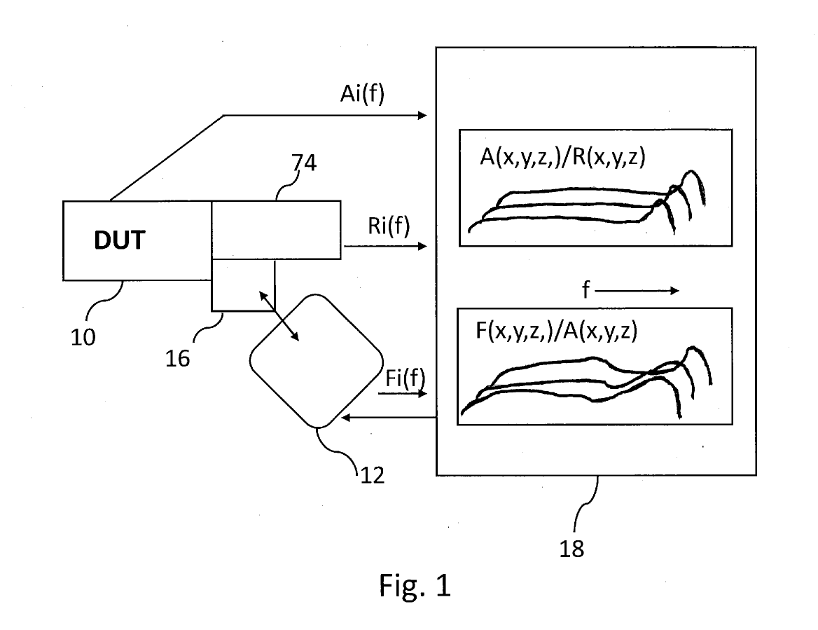

FIG. 1 schematically shows an example of a system for calibrating a test vibration transducer 10 (also referred to as “DUT” (device under test) in the figures), which displays a vibration generator 12, a reference vibration transducer 14, and a fastening device 16, which is used for the purpose of rigidly coupling the reference vibration transducer 14 on the test vibration transducer 10 and connecting the vibration generator 12 to the reference vibration transducer 14 and the test vibration transducer 10, in order to set the reference vibration transducer 14 and the test vibration transducer 16 jointly into vibrations by means of the vibration generator 12.

The system furthermore comprises an analysis unit 18, which has an input for each vibration measurement channel Ai(f) of the test vibration transducer 10 and an input for each reference measurement channel Ri(f) of the reference vibration transducer 14 (“f” indicates the vibration frequency).

The vibration generator 12 is preferably designed to output a force signal Fi(f) for each spatial direction of the vibration excitation corresponding to the force applied for the vibration excitation in this spatial direction to the analysis unit 18, which has corresponding inputs for the force signal. The vibration generator 12 typically has at least one coil for electromagnetic vibration generation, wherein the force signal then results from compensated coil currents.

The reference vibration transducer 14 has a corresponding reference measurement channel for each vibration measurement channel of the test vibration transducer 10 and also at least one additional reference measurement channel for an additional degree of freedom. The test vibration transducer 10 has at least one vibration measurement channel, typically three vibration measurement channels, namely one for each spatial direction. If the test vibration transducer 10 is such a three-axis transducer, the reference vibration transducer 14 has at least six reference measurement channels, namely at least one for each of the six degrees of freedom of a body. The reference measurement channels are preferably translational channels spaced apart from one another, from which the six degrees of freedom are determinable. The reference measurement channels of the reference vibration transducer 14 provided in addition to the measurement channels of the test vibration transducer 10 are significant above all at high frequencies, at which the two vibration transducers 10, 14 can no longer be considered to be rigid bodies.

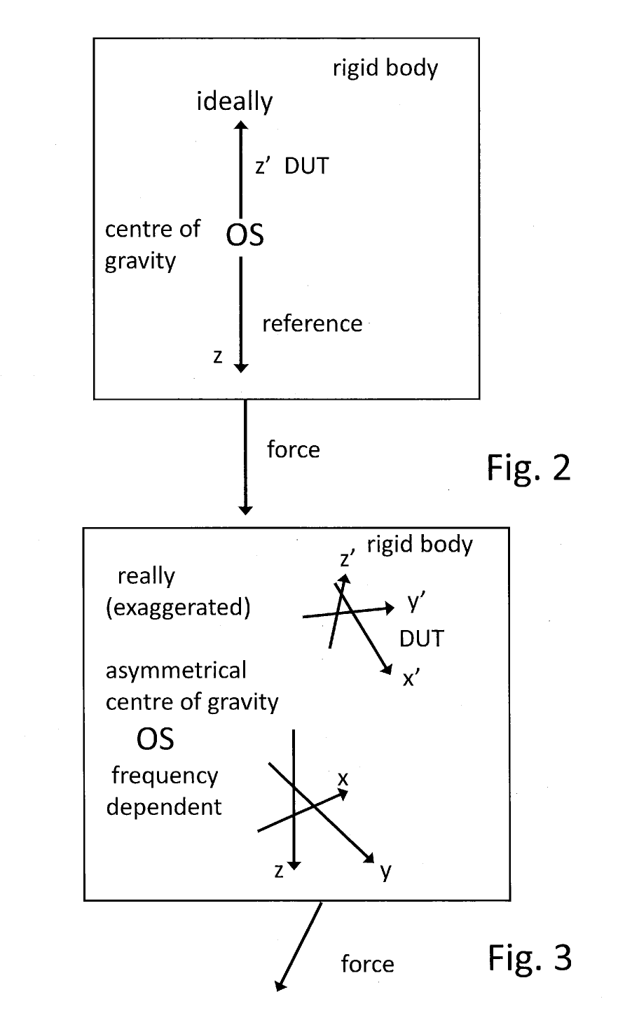

Due to the reliable acquisition of all degrees of freedom by means of the reference vibration transducer 14, in particular bending vibrations of the test vibration transducer 10 can also be recognized, which otherwise corrupt the measurement results. Such bending vibrations are caused by asymmetries in the spatial measuring assembly. This is schematically illustrated in FIGS. 2 and 3, wherein an ideal arrangement is shown in FIG. 2, in which the vibration excitation force and the accelerations of the vibration transducer 10 and the reference vibration transducer 14 resulting therefrom are parallel or antiparallel to one another, since, on the one hand, the corresponding axes (in the example of FIG. 2, the z axis) are parallel to one another and parallel to the direction of the acceleration force and moreover the centre of gravity S of the overall system made of test vibration transducer 10 and reference vibration transducer 14 is located symmetrically with respect to the excitation force, and therefore the vibration excitation force engages at the centre of gravity.

A real construction is shown in an exaggerated illustration in the illustration of FIG. 3, in which, on the one hand, the corresponding axes of the vibration transducers 10 and 14 are not parallel to one another and furthermore the centre of gravity S of the overall system is also located asymmetrically in a frequency-dependent manner with respect to the engaging vibration excitation force (acceleration force) and with respect to the axes of the transducers 10 and 14; furthermore, the acceleration force in the example of FIG. 3 also does not engage parallel to the corresponding axes (z axis) of the transducers 10 and 14. Such asymmetries and misorientations of the vibration transducer axes result in bending vibrations, which corrupt the measurement results of the test vibration transducer 10 and the reference vibration transducer 14, and therefore in particular the signals of the x, y, z channels of the reference vibration transducer 14 are not comparable directly to the corresponding channels of the test vibration transducer 10, if the corresponding misorientations are not taken into consideration.

In the analysis unit 18, the measurement channels of the test vibration transducer 10 are offset with the reference channels of the reference vibration transducer 14 in such a manner that misorientations of the measurement axes of the test vibration transducer 10 in relation to the measurement axes of the reference vibration transducer 14 (i.e., displacement, tilting, and/or rotation of the measurement axes) can be determined; furthermore, the sensitivity of the test vibration transducer 10 and the phasing of the vibration measurement signal of the test vibration transducer 10 in relation to the vibration measurement signal of the reference vibration transducer 14 are determined from the comparison of the measurement signals of the test vibration transducer 10 and the reference vibration transducer 14. Cross-sensitivities of the test vibration transducer 10 can be ascertained from the ascertained misorientations of the measurement axes. The ascertained misorientations of the measurement axes are taken into consideration in the analysis of the measurement signals, to avoid a flawed calibration as much as possible.

The complex mechanical impedance Ii(f)=Fi(f)/Ri(f) can be ascertained with the aid of the force signal of the vibration generator 12, from which in particular the asymmetry of the mechanical impedance of the overall system made of test vibration transducer 10, reference vibration transducer 14, and vibration generator 12 results. The uncertainty of the measurement results of the test vibration transducer 10 can be ascertained from the ascertained mechanical impedance and the ascertained misorientations of the measurement axes of the test vibration transducer 10.

The measurement signals of the test vibration transducer 10 and/or the reference vibration transducer 14 can be the typical vibration signals, i.e., vibration deflection, vibration velocity, or vibration acceleration.

The vibration generator 12 is preferably designed as portable and enables a broadband excitation in a frequency range preferably between 1 Hz and 50 kHz. The excitation is to take place in as many degrees of freedom as possible and at as many different frequencies as possible; in this case, the typical excitation methods can be used, for example, pulse excitation, by hand, excitation by means of noise, or excitation by means of frequency sweep. The vibration generator 12 is controlled in this case by the analysis unit 18.

It can possibly be advantageous for design reasons to provide further reference channels in addition to the six reference channels, which correspond to the six degrees of freedom.

What is claimed is:

1. A system for calibrating a test vibration transducer comprising at least one vibration measurement channel for outputting vibration measurement signals, comprising a vibration generator, a reference vibration transducer, a fastening device for rigidly coupling the reference vibration transducer to the test vibration transducer, in order to set the reference vibration transducer and the test vibration transducer into vibrations jointly by means of the vibration generator, and an analysis unit,
wherein the reference vibration transducer is designed to output a corresponding reference measurement channel for each vibration measurement channel of the test vibration transducer and also at least one additional reference measurement channel for an additional degree of freedom to the analysis unit,
wherein the analysis unit is designed to offset the vibration measurement signals of the test vibration transducer with the reference signals, in order to determine the sensitivity of the test vibration transducer and the phasing of the vibration measurement signals of the test vibration transducer in relation to the vibration measurement signals of the reference vibration transducer and to determine misorientations of the measurement axes of the test vibration transducer in relation to the measurement axes of the reference vibration transducer.

2. The system according to claim 1, wherein the test vibration transducer has three vibration measurement channels.

3. The system according to claim 2, wherein the reference vibration transducer is designed to output at least one reference measurement channel to the analysis unit in each case for all six degrees of freedom.

4. The system according to claim 3, wherein the reference channels are translational channels spaced apart from one another, from which the degrees of freedom are determinable.

5. The system according to claim 2, wherein the reference vibration transducer is designed to output at least eight reference measurement channels to the analysis unit.

6. The system according to claim 1, wherein the vibration generator is designed as portable.

7. The system according to claim 1, wherein the vibration generator is designed for a broadband excitation in the frequency range between 1 Hz and 50 kHz.

8. The system according to claim 1, wherein the vibration generator is designed to output a force signal for each spatial direction of the vibration excitation corresponding to the force applied for the vibration excitation in this spatial direction to the analysis unit.

9. The system according to claim 8, wherein the analysis unit is designed to ascertain the complex mechanical impedance of the overall system made of test vibration transducer, reference vibration transducer, and vibration generator from the force signals and the reference signals.

10. The system according to claim 9, wherein the vibration generator has at least one coil, wherein the force signal results from compensated coil currents.

11. The system according to claim 10, wherein the analysis unit is designed to determine the asymmetry of the mechanical impedance from the ascertained mechanical impedance.

12. The system according to claim 11, wherein the analysis unit is designed to determine the uncertainty of the measurement results of the test vibration transducer and the misorientations of the measurement axes of the test vibration transducer separately.

13. The system according to claim 12, wherein the analysis unit is designed to store the ascertained uncertainty of the measurement results of the test vibration transducer and the ascertained misorientations of the measurement axes of the test vibration transducer in the test vibration transducer.

14. The system according to claim 1, wherein the measurement signals of the test vibration transducer and the reference vibration transducer are a vibration deflection, a vibration velocity, or a vibration acceleration.

15. A method for calibrating a test vibration transducer, wherein
a reference vibration transducer is rigidly coupled to the test vibration transducer,
the reference vibration transducer and the test vibration transducer are jointly set into vibrations by means of a vibration generator,
the test vibration transducer outputs at least one vibration measurement channel,
the reference vibration transducer outputs a corresponding reference measurement channel for each vibration measurement channel of the test vibration transducer and also at least one additional reference measurement channel for an additional degree of freedom,
the signals of the at least one vibration measurement channel of the test vibration transducer are offset with the signals of the reference measurement channels to determine the sensitivity of the test vibration transducer and the phasing of the vibration measurement signals of the test vibration transducer in relation to the vibration measurement signals of the reference vibration transducer and to determine misorientations of the measurement axes of the test vibration transducer in relation to the measurement axes of the reference vibration transducer, and
the test vibration transducer is calibrated on the basis of the ascertained sensitivity, phasing, and measurement axis misorientations.
